(19) United States
(12) Patent Application Publication
(10) Pub. No.: US 2026/0131600 A1
(43) Pub. Date: May 14, 2026

(54) RETREADED TIRE

(71) Applicant: SUMITOMO RUBBER INDUSTRIES, LTD., Kobe-shi (JP)

(72) Inventor: Kazuya NISHIO, Kobe-shi (JP)

(73) Assignee: SUMITOMO RUBBER INDUSTRIES, LTD., Kobe-shi, (JP)

(21) Appl. No.: 19/367,394

(22) Filed: Oct. 23, 2025

(30) Foreign Application Priority Data
Nov. 8, 2024 (JP) 2024-196205

(51) Int. Cl. B60C 11/02; B60C 1/00; C08J 5/12; C08K 3/36; C08L 9/06

(52) U.S. Cl. CPC B60C 11/02; B60C 1/0016; C08J 5/124; C08K 3/36; C08L 9/06; C08J 2309/06; C08J 2475/04; C08K 2201/011

(57) ABSTRACT

Provided is a retreaded tire comprising a base tire, a tread member, and an adhesive layer, wherein the adhesive layer is arranged between the base tire and the tread member, wherein the tread member is composed of a rubber composition, wherein the adhesive layer is composed of a resin-based adhesive, and wherein a value of 70° C. tan δ×(Tc/Ta) is 4.00 or more, where Tc represents a thickness, in mm, of the tread member, Ta represents a thickness, in mm, of the adhesive layer, and 70° C. tan δ represents a loss tangent at 70° C. of the rubber composition. Deterioration of ride comfort is suppressed while using the resin-based adhesive.

### CROSS-REFERENCE TO RELATED APPLICATIONS

This application claims priority to JP Application No. 2024-196205, filed on Nov. 8, 2024, the disclosure of which is expressly incorporated herein by reference in its entirety.

### TECHNICAL FIELD

The present invention relates to a retreaded tire.

### BACKGROUND OF THE INVENTION

For the purpose of realization of a sustainable society, a spread of retread technology together with further improvement of fuel efficiency and vehicle weight reduction has been required for automobiles. Generally, a retreaded tire is produced by vulcanizing a base tire and a tread member to bond them, as described in JP 2023-77089 A.

### SUMMARY OF THE INVENTION

When a retreaded tire is produced without relying on vulcanization, for example, by bonding a base tire and a tread with a resin-based adhesive, large-scale equipment for vulcanization becomes unnecessary, which is convenient. However, since the resin-based adhesive is harder than an adhesive layer consisting of a conventional cushion rubber and the like, there is a concern about deterioration of ride comfort.

It is an object of the present invention to provide a retreaded tire in which deterioration of ride comfort is suppressed while using a resin-based adhesive.

The present invention relates to the following retreaded tire.

A retreaded tire comprising a base tire, a tread member, and an adhesive layer,
wherein the adhesive layer is arranged between the base tire and the tread member,
wherein the tread member is composed of a rubber composition,
wherein the adhesive layer is composed of a resin-based adhesive, and
wherein a value of 70° C. tan δ×(Tc/Ta) is 4.00 or more,
where Tc represents a thickness, in mm, of the tread member, Ta represents a thickness, in mm, of the adhesive layer, and 70° C. tan δ represents a loss tangent at 70° C. of the rubber composition.

According to the present invention, a retreaded tire in which deterioration of ride comfort is suppressed while using a resin-based adhesive can be provided.

### BRIEF DESCRIPTION OF THE DRAWINGS

FIG. 1 is a schematic view showing a part of a cross section of the retreaded tire relating to one embodiment of the present invention taken along a plane including a tire rotation axis (the upper-side part of the cross section).

FIG. 2 is a cross-sectional view showing one example of a base tire and a tread member that are used for a producing method of the retreaded tire.

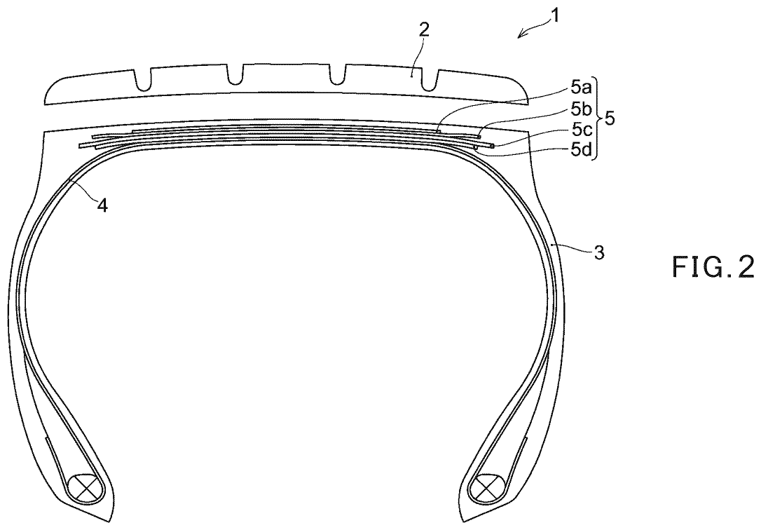

### DETAILED DESCRIPTION

A retreaded tire that is one embodiment of the present invention will be described below. The retreaded tire of the present embodiment is as follows.

A retreaded tire comprising a base tire, a tread member, and an adhesive layer,
wherein the adhesive layer is arranged between the base tire and the tread member,
wherein the tread member is composed of a rubber composition,
wherein the adhesive layer is composed of a resin-based adhesive, and
wherein a value of 70° C. tan δ×(Tc/Ta) is 4.00 or more,
where Tc represents a thickness, in mm, of the tread member, Ta represents a thickness, in mm, of the adhesive layer, and 70° C. tan δ represents a loss tangent at 70° C. of the rubber composition.

Although it is not intended to be bound by a theory, in the present embodiment, the following can be considered as a mechanism by which deterioration of ride comfort is suppressed. That is, in the retreaded tire of the present embodiment, a product of (a) a ratio (Tc/Ta) of the thickness Tc of the tread member to the thickness Ta of the adhesive layer and (b) the loss tangent at 70° C. (70° C. tan δ) of the rubber composition constituting the tread member is adjusted to be equal to or greater than a certain value, and in a case where Tc/Ta is large, it is considered that the relatively thick tread member absorbs a shock that the tire receives from a road surface during running, thereby suppressing deterioration of ride comfort. On the other hand, in a case where Tc/Ta is small, it is considered that an insufficient thickness of the tread member is compensated by increasing 70° C. tan δ of the rubber composition constituting the tread member, thereby suppressing deterioration of ride comfort. That is, when 70° C. tan δ of the rubber composition constituting the tread member is large, the tread member can convert energy inputted from the road surface during running into thermal energy, whereby it is considered that deterioration of ride comfort is suppressed. As described above, it is considered that the retreaded tire of the present embodiment in which the product of Tc/Ta and 70° C. tan δ is kept equal to or greater than the certain value can suppress deterioration of ride comfort while using the resin-based adhesive.

The rubber composition preferably comprises a styrene-butadiene rubber.

This is because both fuel efficiency and abrasion resistance can be achieved while exerting the effects of the present invention.

The rubber composition preferably comprises silica.

This is because both fuel efficiency and abrasion resistance can be achieved while exerting the effects of the present invention.

An average primary particle size of the silica is preferably less than 17 nm.

This is because both fuel efficiency and abrasion resistance can be achieved while exerting the effects of the present invention.

Tc/Ta is preferably greater than 25.0.

This is because such Tc/Ta is advantageous for absorption of a shock by the tread member.

Ta is preferably less than 2.0.

This is because such Ta is advantageous for absorption of a shock by the tread member.

The value of 70° C. tan δ×(Tc/Ta) is preferably 4.20 or more, more preferably 5.00 or more.

This is because such an aspect is an aspect that can further exert the effects of the present invention.

A glass transition temperature of the adhesive layer after curing is preferably higher than 20° C.

This is because such an aspect is an aspect that can further exert the effects of the present invention.

The resin-based adhesive is preferably a urethane resin-based adhesive.

This is because such an aspect is an aspect that can further exert the effects of the present invention.

A content of the silica in the rubber composition is preferably 70 parts by mass or less based on 100 parts by mass of the rubber component.

This is because both fuel efficiency and abrasion resistance can be achieved while exerting the effects of the present invention.

### Definition

A “standardized state” is a state in which the tire is rim-assembled to a standardized rim, filled with air at a standardized internal pressure, and applied with no load. Unless otherwise noted, a tire in a standardized state is used.

A “dimension of each part of a tire” is a value specified in a standardized state for one appearing on the outer surface of the tire, unless otherwise specified, while it is a value specified, for example, in a condition where the tire is cut on a plane including a tire rotation axis and the cut tire piece is held with a rim width of a standardized rim, for one present inside the tire or on a tire cutting surface.

A “standardized rim” is a rim, in a standard system including a standard on which the tire is based, defined for each tire by the standard. For example, the “standardized rim” refers to a standard rim of an applicable size described in “JATMA YEAR BOOK” in JATMA (The Japan Automobile Tyre Manufacturers Association, Inc.), “Measuring Rim” described in “STANDARDS MANUAL” in ETRTO (The European Tyre and Rim Technical Organisation), or “Design Rim” described in “YEAR BOOK” in TRA (The Tire and Rim Association, Inc.), to which references are made in this order, and if there is an applicable size at the time of the reference, the rim conforms to its standard. Besides, in a case of a tire that is not defined by the standard, the “standardized rim” shall refer to a rim having the narrowest rim width among rims that can be rim-assembled to the tire, that can maintain an internal pressure (that is, do not cause air leakage between the rim and the tire), and that have the smallest rim diameter.

A “standardized internal pressure” is an air pressure, in a standard system including a standard on which the tire is based, defined for each tire by the standard, for example, it refers to a “MAXIMUM AIR PRESSURE” in JATMA, “INFLATION PRESSURE” in ETRTO, or a maximum value described in Table “TIRE LOAD LIMITS AT VARIOUS COLD INFLATION PRESSURES” in TRA, to which references are made in this order as in the case of the standardized rim, and if there is an applicable size at the time of the reference, the standardized internal pressure conforms to its standard. Besides, in the case of tires that are not defined by the standard, the standardized internal pressure shall refer to a standardized internal pressure (250 KPa or more) of another tire size (specified in the standard) for which the standardized rim is described as a standard rim, and when a plurality of standardized internal pressures of 250 KPa or more are described, it shall refer to the minimum value among them.

A “standardized load, in kg” is a load, in a standard system including a standard on which the tire is based, defined for each tire by the standard, for example, a “MAXIMUM LOAD CAPACITY” in JATMA, a “LOAD CAPACITY” in ETRTO, or a maximum value described in Table “TIRE LOAD LIMITS AT VARIOUS COLD INFLATION PRESSURES” in TRA, to which references are made in this order as in cases of a standardized rim and a standardized internal pressure, and if there is an applicable size at the time of the reference, the load conforms to its standard. Then, in the case of tires that are not defined by the standard, a maximum load capacity W_{L} obtained by a calculation is defined as a standardized load.

A “maximum load capacity W_{L}, in kg” is calculated by the following equation. “V” represents a virtual volume, in mm³, of a tire, “Dt” represents a tire outer diameter, in mm, in a standardized state, “Ht” represents a cross-sectional height, in mm, of the tire in a tire radial direction on a cross section of the tire taken along a plane including a tire rotation axis, and “Wt” represents a cross-sectional width, in mm, of the tire in the standardized state. When R represents a rim diameter of the tire, Ht can be calculated by the following equation: (Dt−R)/2. Wt is a value obtained by excluding, if any, patterns, letters, or the like on the side surface of the tire. Besides, the maximum load capacity has the same meaning as a standardized load described above.

$$\begin{matrix}{W}_{L} = 0.000011 \times V + 175 \\ V = [ {( Dt / 2 )}^{2} - {( Dt / 2 - Ht )}^{2} ] \times π \times Wt\end{matrix}$$

A “base tire” is a part of a tire that remains when a tread part is removed, for the purpose of retreading the tire, from the tire whose tread is abraded due to use of the tire. The tire can be used as a retreaded tire by adding a new tread member.

A “tread member” is a part of a tire added to a base tire in order to use the base tire as a retreaded tire.

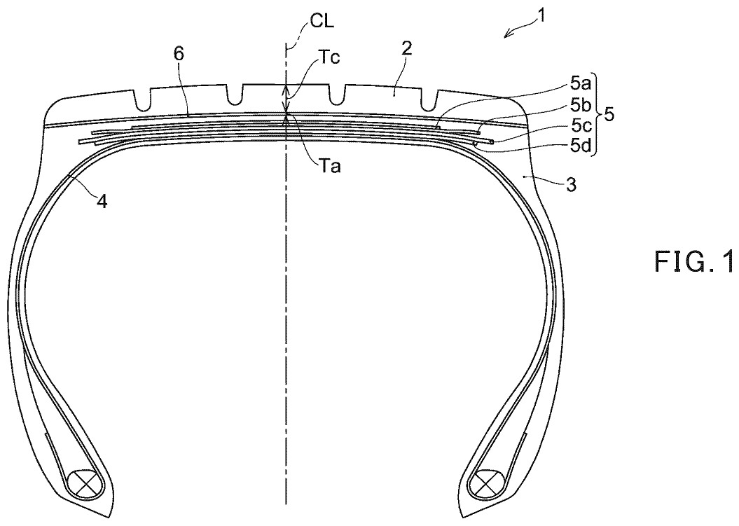

A “thickness Tc of a tread member” is a thickness, in mm, of a tread member measured along a tire center line on a cross section of a tire taken along a plane including a tire rotation axis. In the present embodiment, Tc is a distance from a tread surface to an end of an adhesive layer on an outer side in a tire radial direction, as shown in FIG. 1. Tc is measured in a state where the tire cut along the plane including the tire rotation axis is held with a standardized rim width. Tc is an average value of thicknesses measured at positions of five locations when the tire is rotated in 72 degree increments in a circumferential direction.

An “adhesive layer” is a layer that is arranged between a base tire and a tread member in order to bond them and that is composed of a resin-based adhesive. Here, the “resin-based adhesive” refers to thermoplastic resin-based and thermosetting resin-based adhesives.

A “thickness Ta of an adhesive layer” is a thickness, in mm, of an adhesive layer measured along a tire center line on a cross section of a tire taken along a plane including a tire rotation axis. In the present embodiment, Ta is a distance from an end of the adhesive layer on an outer side in a tire radial direction to an end of the adhesive layer on an inner side in the tire radial direction, as shown in FIG. 1. Ta is measured in a state where the tire cut along the plane including the tire rotation axis is held with a standardized rim width. Ta is an average value of thicknesses measured at positions of five locations when the tire is rotated in 72 degree increments in a circumferential direction.

### <Measuring Method>

“70° C. tan δ of a rubber composition” is a loss tangent (tan δ) measured, using a dynamic viscoelasticity measuring device (for example, EPLEXOR series manufactured by gabo Systemtechnik GmbH), under a condition of a temperature at 70° C., a frequency of 10 Hz, an initial strain of 10%, a dynamic strain of ±1%, and an extension mode. A sample for measurement is a vulcanized rubber composition having a length of 20 mm, a width of 4 mm, and a thickness of 1 mm. In a case where the sample is prepared by being cut out from a tire, a length direction of the sample is made to coincide with a tire circumferential direction and a thickness direction of the sample is made to coincide with a tire radial direction. Besides, in a case where it is difficult to collect the sample for measurement with a thickness of 1 mm becomes, the sample has only to be collected in a state where its thickness is made to approximate 1 mm as much as possible. This is because it is considered that there is no influence of the thickness since elongation at break is measured as a standardized value.

A “glass transition temperature” is a static glass transition temperature calculated by a differential scanning calorimeter (for example, Q200 manufactured by TA Instruments Japan Inc.).

A “styrene content” is calculated by pyrolysis gas chromatography or NMR measurement (¹H-NMR or ¹³C-NMR). For a component amount such as a “styrene content”, there is a true value that does not depend on any measuring methods, unlike physical property values such as a complex elastic modulus (E*) and the like. Therefore, it is preferable to use a measuring method that is as highly accurate as possible. Besides, in the present specification, “pyrolysis gas chromatography” refers to a method of heating a sample by a pyrolysis device, separating individual components contained in a gas-phase component generated by this heating from one another using a separation column, and analyzing each isolated component.

A “vinyl content (1,2-bond butadiene unit amount)” is calculated by pyrolysis gas chromatography or NMR measurement (¹H-NMR or ¹³C-NMR). Also for a “vinyl content”, there is a true value that does not depend on any measuring methods, like a “styrene content”. Therefore, it is preferable to use a measuring method that is as highly accurate as possible.

A “cis content (cis-1,4-bond butadiene unit amount)” is a value measured by infrared absorption spectrometry in accordance with JIS K 6239-2:2017 or NMR measurement (¹H-NMR or ¹³C-NMR) and is applied to a rubber component having a repeating unit derived from butadiene such as, for example, a BR and the like. Also for a “cis content”, there is a true value that does not depend on any measuring methods, like a “styrene content”. Therefore, it is preferable to use a measuring method that is as highly accurate as possible.

A “weight-average molecular weight (Mw)” can be calculated in terms of a standard polystyrene based on measurement values obtained by a gel permeation chromatography (GPC) (for example, GPC-8000 Series manufactured by Tosoh Corporation, detector: differential refractometer, column: TSKgel (Registered Trademark) SuperMultiporeHZ-M manufactured by Tosoh Corporation). For example, it is applied to an SBR, a BR, a plasticizing agent, and the like.

A “nitrogen adsorption specific surface area (N₂SA) of carbon black” is measured according to JIS K 6217-2:2017.

A “nitrogen adsorption specific surface area (N₂SA) of silica” is measured by a BET method according to ASTM D3037-93.

An “average primary particle size” is values calculated by an arithmetic mean of particle sizes of 400 particles which are photographed with a transmission or scanning electron microscope. In a case where the particle is in a spherical shape, a diameter of the sphere is defined as a particle size, and in cases of shapes other than the spherical shape, an equivalent circle diameter (positive square root of “4×(area of particle)/π”) calculated from a microscope image is defined as a particle size.

A “plasticizing agent” is a material giving a rubber component plasticity and is a component extracted from a rubber composition using acetone. Moreover, examples of the plasticizing agent include a plasticizing agent that is liquid or in a liquid state at 25° C. and a plasticizing agent that is solid at 25° C. However, the plasticizing agent shall not include wax and stearic acid commonly used in the tire industry.

A “content of a plasticizing agent” also includes an amount of a plasticizing agent that is contained in a rubber component extended by the plasticizing agent.

Unless otherwise noted, a “softening point of a resin component or the like” is a temperature at which a sphere drops when the softening point specified in JIS K 6220-1:2015 is measured with a ring and ball softening point measuring device. A softening point measured by another method will be described accordingly.

An embodiment will be described below in further detail. However, the tease descriptions are illustrative for detailed explanation. Moreover, although the embodiment will be described by appropriately using the drawings, the drawings are also merely illustrative.

### <Retreaded Tire>

FIG. 1 is a cross-sectional view of a retreaded tire relating to one embodiment. Hereinafter, the retreaded tire may be simply referred to as a tire. A retreaded tire 1 shown in FIG. 1 comprises a base tire 3 comprising a carcass 4 and a belt 5, and a tread member 2 arranged on the outer side of the base tire in a radial direction (the upper region in the drawing, the same applies hereinafter), from the inner side in the tire radial direction (the lower region in the drawing, the same applies hereinafter). An adhesive layer 6 is arranged between the tread member 2 and the base tire 3 and bonds the tread member 2 and the base tire 3. The tread member 2 is composed of a rubber composition, and the adhesive layer 6 is composed of a resin-based adhesive.

In the tire 1, a thickness of the tread member on a tire center line CL is denoted by Tc, and a thickness of the adhesive layer on the tire center line CL is denoted by Ta. Besides, the tread member may be one consisting of two layers of a cap tread and a base tread or may be one further consisting of three or more layers. In a case where the tread member consists of two or more layers, the thickness of the tread member means a total thickness of all the layers.

$$( 70 ° C . tan δ \times ( Tc / Ta ) )$$

In the tire of the present embodiment, a value of 70° C. tan δ×(Tc/Ta) is 4.00 or more, where Tc represents a thickness, in mm, of the tread member, Ta represents a thickness, in mm, of the adhesive layer, and 70° C. tan δ represents a loss tangent at 70° C. of the rubber composition constituting the tread member.

The value of 70° C. tan δ×(Tc/Ta) is preferably 4.10 or more, more preferably 4.20 or more, further preferably 4.50 or more, further preferably 5.00 or more, further preferably 5.20 or more, further preferably 5.30 or more, further preferably 5.40 or more. On the other hand, an upper limit of the value is not particularly limited and is about 50.00.

The value of 70° C. tan δ×(Tc/Ta) can be adjusted by adjusting the value of 70° C. tan δ of the rubber composition constituting the tread member, the thickness Tc of the tread member, and the thickness Ta of the adhesive layer. Among them, 70° C. tan δ can be adjusted by a method described below.

### (Tc/Ta)

The value of Tc/Ta is preferably greater than 27.0, more preferably greater than 29.0, further preferably 30.0 or more, further preferably 40.0 or more, further preferably 50.0 or more, further preferably 60.0 or more. On the other hand, the value is preferably 300.0 or less. When the value of Tc/Ta is within the above-described ranges, the effects of the present invention tend to be easily achieved while securing adhesiveness between the tread member and the base tire.

### (Thickness Tc of Tread Member)

The thickness Tc of the tread member varies depending on types of a tire. Therefore, Tc can be various thicknesses, and in one embodiment, for example, Tc is preferably 10 mm or more, more preferably 11 mm or more, further preferably 12 mm or more, further preferably 13 mm or more, further preferably 14 mm or more, further preferably 15 mm or more. On the other hand, Tc in the present embodiment is preferably 35 mm or less, more preferably 34 mm or less, further preferably 33 mm or less, further preferably 32 mm or less, further preferably 31 mm or less, further preferably 30 mm or less.

### (Thickness Ta of Adhesive Layer)

The thickness Ta of the adhesive layer varies depending on types of a tire. Therefore, Ta can be various thicknesses, and in one embodiment, for example, Ta is preferably 0.1 mm or more, more preferably 0.3 mm or more, further preferably 0.5 mm or more. On the other hand, Ta in the present embodiment is preferably 5.0 mm or less, more preferably 4.0 mm or less, further preferably 3.0 mm or less, further preferably less than 2.0 mm, further preferably less than 1.0 mm.

### (70° C. tan δ)

70° C. tan δ of the rubber composition constituting the tread member is preferably 0.07 or more, more preferably 0.08 or more, further preferably greater than 0.10. On the other hand, 70° C. tan δ is preferably less than 0.20, more preferably less than 0.19, further preferably 0.18 or less.

70° C. tan δ can be increased by increasing a compounding amount of a filler such as silica, carbon black, and the like or a plasticizing agent such as a resin component, oil, and the like, and conversely, it can be decreased by decreasing the amount of the filler or the plasticizing agent.

### <Rubber Composition Constituting Tread Member>

The rubber composition constituting the tread member will be described below.

### (Rubber Component)

As a rubber component, a cross-linkable rubber component commonly used in the tire industry can be used, and examples of such a rubber component include, for example, a diene-based rubber such as an isoprene-based rubber (IR-based rubber), a styrene-butadiene rubber (SBR), a butadiene rubber (BR), a styrene-isoprene-butadiene copolymer rubber (SIBR), a styrene-isobutylene-styrene block copolymer (SIBS), a chloroprene rubber (CR), an acrylonitrile-butadiene rubber (NBR), and the like. The diene-based rubber components may be used alone, or two or more thereof may be used in combination.

Moreover, the rubber component may be one comprising a non-diene-based rubber such as a hydrogenated nitrile rubber (HNBR), a butyl rubber (IIR), an ethylene propylene rubber, a polynorbornene rubber, a silicone rubber, a polyethylene chloride rubber, a fluororubber (FKM), an acrylic rubber (ACM), a hydrin rubber, and the like. The non-diene-based rubber components may be used alone, or two or more thereof may be used in combination.

Moreover, besides the above-described rubber components, the rubber component may or may not comprise a known thermoplastic elastomer.

As one preferred aspect, the rubber component comprises an isoprene-based rubber and a butadiene rubber and more preferably consists of an isoprene-based rubber and a butadiene rubber. As another preferred aspect, the rubber component comprises a styrene-butadiene rubber and an isoprene-based rubber and/or a butadiene rubber, more preferably comprises a styrene-butadiene rubber, an isoprene-based rubber, and a butadiene rubber, and further preferably consists of a styrene-butadiene rubber, an isoprene-based rubber, and a butadiene rubber.

### <<Isoprene-Based Rubber>>

As an isoprene-based rubber, for example, those common in the tire industry can be used, such as an isoprene rubber (IR), a natural rubber, and the like. Examples of the natural rubber include an unmodified natural rubber (NR), as well as a modified natural rubber such as an epoxidized natural rubber (ENR), a hydrogenated natural rubber (HNR), a deproteinized natural rubber (DPNR), an ultra pure natural rubber (UPNR), a grafted natural rubber, and the like. The isoprene-based rubbers may be used alone, or two or more thereof may be used in combination.

The NR is not particularly limited, and those common in the tire industry can be used, examples of which include, for example, SIR20, RSS #3, TSR20, and the like.

A content of an isoprene-based rubber in the rubber component is preferably greater than 30% by mass, more preferably greater than 40% by mass, further preferably greater than 50% by mass. On the other hand, the content is preferably less than 90% by mass, more preferably less than 80% by mass, further preferably less than 70% by mass.

### <<SBR>>

The SBR is not particularly limited, and any of a solution-polymerized SBR (S-SBR) and an emulsion-polymerized SBR (E-SBR) can be appropriately used. However, an S-SBR is preferable from the viewpoint of the effects of the present invention. Moreover, as the SBR, modified SBRs (a modified S-SBR, a modified E-SBR) thereof can be used. Examples of the modified SBR include an SBR modified at its terminal and/or main chain, a modified SBR coupled with tin, a silicon compound, etc. (a modified SBR of condensate or having a branched structure, etc.), and the like. The SBRs may be used alone, or two or more thereof may be used in combination.

An oil-extended SBR or a non-oil extended SBR can be used as an SBR. Those commercially available from JSR Corporation, Sumitomo Chemical Co., Ltd., UBE Corporation, Asahi Kasei Corporation, ZS Elastomer Co., Ltd., ARLANXEO, etc. can be used as the SBR.

A styrene content of an SBR is preferably greater than 5% by mass, more preferably greater than 7% by mass, further preferably 10% by mass or more, from the viewpoints of wet grip performance and abrasion resistance. Moreover, it is preferably less than 40% by mass, more preferably less than 30% by mass, further preferably less than 20% by mass, from the viewpoints of temperature dependency of grip performance and abrasion resistance. The styrene content of the SBR is measured by the above-described measuring method.

A vinyl content of an SBR is preferably greater than 10 mol %, more preferably greater than 20 mol %, further preferably greater than 30 mol %, from the viewpoints of wet grip performance and abrasion resistance. Moreover, the vinyl content of the SBR is preferably less than 60 mol %, more preferably less than 50 mol %, further preferably less than 30 mol %, from the viewpoints of wet grip performance and abrasion resistance. The vinyl content of the SBR (1,2-bond butadiene unit amount) is measured by the above-described measuring method.

A glass transition point (Tg) of an SBR is preferably higher than −80° C., more preferably higher than −70° C., further preferably higher than −65° C., from the viewpoint of wet grip performance. Moreover, the Tg of the SBR is preferably lower than −30° C., more preferably lower than −35° C., further preferably lower than −40° C., from the viewpoint of fuel efficiency. The Tg of the SBR is measured by the above-described measuring method.

A weight-average molecular weight (Mw) of an SBR is preferably 100,000 or more, more preferably 150,000 or more, further preferably 190,000 or more, from the viewpoint of abrasion resistance. Moreover, the Mw is preferably 2,500,000 or less, more preferably 2,000,000 or less, further preferably 1,000,000 or less, from the viewpoints of cross-linking uniformity, etc. The Mw of the SBR is measured by the above-described measuring method.

A content of an SBR when compounded in the rubber component is preferably greater than 5% by mass, more preferably greater than 10% by mass, further preferably greater than 15% by mass, from the viewpoints of abrasion resistance and wet grip performance. Moreover, the content is preferably less than 40% by mass, more preferably less than 30% by mass, further preferably less than 25% by mass, from the viewpoint of abrasion resistance.

### <<BR>>

The BR is not particularly limited, and those common in the tire industry can be used, such as, for example, a BR having a cis content less than 50 mol % (a low cis BR), a BR having a cis content of 90 mol % or more (a high cis BR), a rare-earth-based butadiene rubber synthesized using a rare-earth element-based catalyst (a rare-earth-based BR), a BR containing a syndiotactic polybutadiene crystal (an SPB-containing BR), a modified BR (a high cis modified BR, a low cis modified BR), and the like. The BRs may be used alone, or two or more thereof may be used in combination.

As the high cis BR, for example, those commercially available form Zeon Corporation, UBE Corporation, JSR Corporation, etc. can be used. When the rubber composition comprises a high cis BR, a low temperature property and abrasion resistance can be improved. A cis content of the high cis BR is preferably greater than 90 mol %, more preferably greater than 95 mol %, further preferably 96 mol % or more. A cis content of a BR is measured by the above-described measuring method.

The rare-earth-based BR includes those which are synthesized using a rare-earth element-based catalyst and have a vinyl content of preferably less than 1.8 mol %, more preferably less than 1.5 mol %, further preferably less than 1.2 mol %, and a cis content of preferably greater than 90 mol %, more preferably greater than 95 mol %, further preferably 96 mol % or more. As the rare-earth-based BR, for example, those commercially available from LANXESS, etc. can be used.

Examples of the SPB-containing BR include those in which 1,2-syndiotactic polybutadiene crystal is chemically bonded with BR and dispersed, but not those in which the crystal is simply dispersed in the BR. As such an SPB-containing BR, those commercially available from UBE Corporation, etc. can be used.

Examples of the modified BR include BRs modified with the same functional groups as described above for the SBR, and the like, and a modified butadiene rubber (modified BR) modified at its terminal and/or main chain with a functional group comprising at least one element selected from the group consisting of silicon, nitrogen, and oxygen can also be appropriately used.

Examples of other modified BRs include those obtained by adding a tin compound after polymerizing 1,3-butadiene by a lithium initiator, the terminal of the modified BR molecule being further bonded by tin-carbon bond (tin-modified BRs), and the like. Moreover, the modified BR may be either non-hydrogenated or hydrogenated.

A weight-average molecular weight (Mw) of a BR is preferably greater than 300,000, more preferably greater than 350,000, further preferably greater than 400,000, from the viewpoint of abrasion resistance. Moreover, it is preferably less than 2,000,000, more preferably less than 1,000,000, further preferably less than 700,000, from the viewpoints of cross-linking uniformity, etc. The Mw of the BR can be calculated by the above-described method.

A content of a BR in the rubber component is, but not particularly limited to, preferably greater than 5% by mass, more preferably greater than 10% by mass, further preferably greater than 15% by mass. Moreover, the content of the BR in the rubber component is preferably less than 60% by mass, more preferably less than 50% by mass, further preferably 40% by mass or less.

<<Rubber Component Synthesized from Recycle-Derived/Biomass-Derived Raw Material>>

A monomer that is a structural unit of a synthetic rubber such as an IR, an SBR, a BR, and the like may be one derived from underground resources such as petroleum, a natural gas, and the like or one recycled from a rubber product such as a tire and the like or a non-rubber product such as polystyrene and the like. Examples of monomers obtained by recycle (recycled monomers) include, but not particularly limited to, a recycle-derived polyisoprene, a recycle-derived butadiene, a recycle-derived aromatic vinyl compound, and the like. Examples of the above-described butadiene include 1,2-butadiene and 1-3 butadiene. Examples of the aromatic vinyl compound include, but not particularly limited to, styrene and the like. Among them, a recycle-derived polyisoprene (recycled isoprene), a recycle-derived butadiene (recycled butadiene), and/or a recycle-derived styrene (recycled styrene) are preferably used as raw materials.

A method of producing a recycled monomer is not particularly limited, examples of which include, for example, synthesis of a recycled monomer from recycle-derived naphtha obtained by decomposing a rubber product such as a tire and the like. Moreover, a method of producing a recycle-derived naphtha is not particularly limited, and a recycle-derived naphtha may be obtained from, for example, a rubber product such as a tire and the like by decomposing it under high temperature and pressure, by decomposing it by microwaves, or by mechanically pulverizing it and then extracting therefrom.

Furthermore, a monomer that is a structural unit of a polymer such as an IR, an SBR, a BR, and the like may be one derived from biomass. In the present specification, “biomass” refers to a material derived from natural resources such as plants and the like. Examples of biomass include, but not particularly limited to, for example, agricultural, forest and fishery products and sugar, wood waste, a plant residue after acquisition of a useful component, a plant-derived ethanol, a biomass naphtha, and the like.

Examples of the biomass-derived monomer (biomass monomer) include, but not particularly limited to, a biomass-derived butadiene, a biomass-derived aromatic vinyl compound, and the like. Examples of the above-described butadiene include 1, 2-butadiene and 1,3-butadiene. Examples of the above-described aromatic vinyl compound include, but not particularly limited to, styrene and the like. Moreover, a method of producing a biomass monomer is not particularly limited, examples of which include, for example, a method by biological and/or chemical and/or physical conversion of an animal or a plant, and the like. A microbial fermentation is representative of biological conversion, and examples of chemical and/or physical conversion include a method using a catalyst, a method using a high heat, a method using a high pressure, a method using an electromagnetic wave, a method using a critical liquid, and combinations thereof.

Examples of a polymer synthesized from a biomass monomer component (biomass polymer) include, but not particularly limited to, a polybutadiene rubber synthesized from a biomass-derived butadiene, an aromatic vinyl/butadiene copolymer synthesized from a biomass-derived butadiene and/or a biomass-derived aromatic vinyl compound, and the like. Examples of the aromatic vinyl/butadiene copolymer include, for example, a styrene-butadiene rubber synthesized from a biomass-derived butadiene and/or a biomass-derived styrene, and the like.

Whether or not a raw material of a polymer is derived from biomass can be determined from percent Modern Carbon (pMC) measured according to ASTM D6866-10. “pMC” means a ratio of ¹⁴C concentration of a sample to ¹⁴C concentration of a modern standard carbon (modern standard reference) and is a value used as an index that indicates a biomass ratio of a compound. A significance of this value will be mentioned below.

In 1 mole of carbon atoms (6.02×10²³), there are about 6.02×10^{11 14}C that are about one trillionth of the number of normal carbon atoms. A half-life of ¹⁴C is 5730 years, and ¹⁴C regularly decreases. Therefore, in fossil fuels such as coal, petroleum, natural gas, and the like, where it is considered that 226,000 years or more have passed since carbon dioxide in the atmosphere and the like was absorbed by plants and the like to be fixed, all of ¹⁴C elements, which were also contained in them at the beginning of fixation, have decayed. Therefore, in the present 21st century, fossil fuels such as coal, petroleum, natural gas, and the like do not contain any ¹⁴C element. Accordingly, chemical substances produced using these fossil fuels as raw materials do not contain any ¹⁴C element as well.

On the other hand, ¹⁴C is constantly generated by cosmic rays causing nuclear reactions in the atmosphere. Therefore, decrease in ¹⁴C due to radioactive decay and generation of ¹⁴C due to nuclear reactions are balanced, and the amount of ¹⁴C has been constant in the atmosphere environment of the earth. Therefore, the ¹⁴C concentration of substances derived from biomass resources that have been circulating in the current environment becomes a value of about 1×10⁻¹² mol % based on the entire carbon atoms, as described above. Accordingly, by utilizing a difference between these values, a biomass ratio in a certain compound can be calculated.

This ¹⁴C is generally measured as follows. A ¹³C concentration (¹³C/¹²C) and a ¹⁴C concentration (¹⁴C/¹²C) are measured using an accelerator mass spectrometry based on a tandem accelerator. In the measurements, a ¹⁴C concentration in a circulating carbon in nature as of 1950 is adopted as the modern standard reference that becomes a reference for the ¹⁴C concentration. As a specific reference material, an oxalic acid standard provided by NIST (National Institute of Standard and Technology) is used. A specific radioactivity of carbon in this oxalic acid (radioactivity intensity of ¹⁴C per gram of carbon) is sorted for each carbon isotope, ¹³C is corrected to be a constant value, and a value corrected for attenuation correction from 1950 to the date of measurement is used as a standard ¹⁴C concentration value (100%). A ratio of this value and a value actually measured for a sample becomes a pMC value.

Thus, if a rubber is produced from a material derived from 100% biomass, the ¹⁴C concentration shows a value of approximately 110 pMC as, currently, under a normal condition, it is often not equal to 100, though there are regional differences and the like. On the other hand, if this ¹⁴C concentration is measured for a chemical substance derived from a fossil fuel such as petroleum and the like, it shows a value of approximately 0 pMC (for example, 0.3 pMC). This value corresponds to a biomass ratio of 0% as mentioned above.

From above, it is appropriate in terms of environmental protection to use a material such as a rubber having a high pMC value and the like, that is, a material such as a rubber having a high biomass ratio and the like, for a rubber composition.

### (Filler)

As a filler, a filler commonly used in the tire industry can be used. The filler preferably comprises silica and/or carbon black. Although the filler can comprise a filler other than silica and carbon black, the filler may be a filler consisting of carbon black or a filler consisting of carbon black and silica. Moreover, the filler may comprise recovered carbon black.

Another filler other than silica and carbon black is not particularly limited, and for example, those conventionally and commonly used in the tire industry, such as aluminum hydroxide, calcium carbonate, alumina, clay, talc, and the like, can be compounded.

The filler may be used alone, or two or more thereof may be used in combination.

### <<Silica>>

Silica is not particularly limited, and those common in the tire industry can be used, such as, for example, silica prepared by a dry process (anhydrous silica), silica prepared by a wet process (hydrous silica), and the like. A raw material of silica is not particularly limited and may be, for example, a raw material derived from a mineral such as quartz or a raw material derived from a biological substance such as rice husks (for example, silica made from a biomass material such as rice husks, and the like), or silica recycled from a product containing silica may be used. Among them, hydrous silica prepared by a wet process is preferable for the reason that it has many silanol groups. The silica may be used alone, or two or more thereof may be used in combination.

Silica made from a biomass material can be obtained by, for example, burning rice husks to obtain rice husk ashes, extracting silicate from the rice husk ashes using a sodium hydroxide solution, generating silicon dioxide by reacting the silicate with sulfuric acid in the same manner as a conventional wet silica, and filtering, washing with water, drying and pulverizing precipitates of the silicon dioxide.

As silica recycled from a product comprising silica, silica recovered from such a product as an electronic component like a semiconductor, a tire, a desiccant, a filtering material like diatomaceous earth, or the like can be used. Moreover, a recovering method is not particularly limited, examples of which include pyrolysis, decomposition by electromagnetic waves, and the like. Among them, silica recovered from an electronic component such as a semiconductor and the like or from a tire is preferable.

When silica crystallizes, it is insoluble in water, and silicic acid that is a component thereof cannot be used. By controlling a burning temperature and a burning time, crystallization of silica in rice husk ashes can be suppressed (see JP 2009-2594 A, Akita Prefectural University Web Journal B/2019, vol. 6, p. 216-222, etc.). As an amorphous silica extracted from rice husks, those commercially available from Wilmar, etc. can be used.

A nitrogen adsorption specific surface area (N₂SA) of silica is preferably greater than 170 m²/g, more preferably greater than 190 m²/g, further preferably greater than 210 m²/g, further preferably greater than 230 m²/g, further preferably 235 m²/g or more, from the viewpoints of abrasion resistance and fracture characteristics. Moreover, the N₂SA is preferably less than 500 m²/g, more preferably less than 350 m²/g, further preferably less than 300 m²/g, further preferably less than 250 m²/g, from the viewpoint of processability. The N₂SA of the silica is a value measured by the above-described measuring method.

An average primary particle size of silica is preferably less than 18 nm, more preferably less than 17 nm, further preferably less than 16 nm, further preferably 15 nm or less, from the viewpoint of the effects of the present invention. Moreover, the average primary particle size is preferably greater than 12 nm, more preferably greater than 13 nm, further preferably greater than 14 nm, from the viewpoint of processability. The average primary particle size of silica is measured by the above-described measuring method.

A content of silica is preferably greater than 20 parts by mass, more preferably greater than 25 parts by mass, further preferably 30 parts by mass or more, based on 100 parts by mass of the rubber component, from the viewpoint of balance between fuel efficiency and wet grip performance. Moreover, the content is preferably less than 150 parts by mass, more preferably less than 100 parts by mass, further preferably less than 80 parts by mass, further preferably 70 parts by mass or less, further preferably less than 60 parts by mass, further preferably 55 parts by mass or less, further preferably less than 45 parts by mass, further preferably less than 35 parts by mass, further preferably 30 parts by mass or less, from the viewpoint of processability.

### <<Silane Coupling Agent>>

The silica is preferably used in combination with a silane coupling agent. The silane coupling agent is not particularly limited, and examples of the silane coupling agent include, for example, a sulfide-based silane coupling agent such as bis(3-triethoxysilylpropyl)disulfide, bis(3-triethoxysilylpropyl)tetrasulfide, and the like; a mercapto-based silane coupling agent such as 3-mercaptopropyltrimethoxysilane, 3-mercaptopropyltriethoxysilane, 2-mercaptoethyltrimethoxysilane, 2-mercaptoethyltriethoxysilane, and the like; a vinyl-based silane coupling agent such as vinyltriethoxysilane, vinyltrimethoxysilane, and the like; an amino-based silane coupling agent such as 3-aminopropyltriethoxysilane, 3-aminopropyltrimethoxysilane, 3-(2-aminoethyl)aminopropyltriethoxysilane, and the like; a glycidoxy-based silane coupling agent such as γ-glycidoxypropyltriethoxysilane, γ-glycidoxypropyltrimethoxysilane, and the like; a nitro-based silane coupling agent such as 3-nitropropyltrimethoxysilane, 3-nitropropyltriethoxysilane, and the like; a chloro-based silane coupling agent such as 3-chloropropyltrimethoxysilane, 3-chloropropyltriethoxysilane, and the like; and the like. Among them, a sulfide-based silane coupling agent and/or a mercapto-based silane coupling agent are preferably compounded in the rubber composition. As the silane coupling agent, for example, those commercially available from Evonik Industries AG, Momentive Performance Materials, etc. can be used. The silane coupling agents may be used alone, or two or more thereof may be used in combination.

A content of a silane coupling agent based on 100 parts by mass of silica is preferably 1 part by mass or more, more preferably 3 parts by mass or more, further preferably 5 parts by mass or more, further preferably 8 parts by mass or more, from the viewpoint of enhancing dispersibility of silica. Moreover, it is preferably 20 parts by mass or less, more preferably 18 parts by mass or less, further preferably 16 parts by mass or less, from the viewpoints of cost and processability.

### <<Carbon Black>>

Examples of carbon black include, but not particularly limited to, N134, N110, N220, N234, N219, N339, N330, N326, N351, N550, N762, and the like. A raw material of carbon black may be a biomass material such as lignin, vegetable oil, and the like or may be pyrolysis oil obtained by pyrolyzing a waste tire. Moreover, a method of producing carbon black may be a method using combustion such as a furnace method, may be a method using hydrothermal carbonization (HTC), or may be a method using pyrolysis of methane by a thermal black method and the like. As a commercially available product, products from ASAHI CARBON CO., LTD., Cabot Japan K.K., TOKAI CARBON CO., LTD., Mitsubishi Chemical Corporation., Lion Corporation., NIPPON STEEL Chemical & Material Co., Ltd., Columbia Carbon Corporation., etc. can be used. The carbon black may be used alone, or two or more thereof may be used in combination.

Moreover, as carbon black other than the above-described carbon black, a recovered carbon black obtained by pyrolyzing a product comprising carbon black such as a tire and the like followed by refining may be used from the viewpoints of a life cycle assessment, etc.

A recovered carbon black can be obtained from a pyrolysis process of a used pneumatic tire. For example, EP 3427975 A describes, with reference to “Rubber Chemistry and Technology”, Vol. 85, No. 3, Pages 408 to 449 (2012), in particular, Pages 438, 440, and 442, that the recovered carbon black can be obtained by pyrolysis at 550 to 800° C. excluding oxygen or vacuum pyrolysis at a relatively low temperature, of an organic material ([0027]). As described in [0004] of JP 6856781 B, such carbon black obtained by the pyrolysis process usually lacks a functional group on its surface (A Comparison of Surface Morphology and Chemistry of Pyrolytic Carbon Blacks with Commercial Carbon Blacks, Powder Technology 160 (2005) 190-193).

The recovered carbon black may be one that lacks a functional group on its surface or may be one treated so as to include a functional group on its surface. The treatment of the recovered carbon black so that the recovered carbon black includes a functional group on its surface can be performed by a usual method. For example, in EP 3173251 A, carbon black obtained from a pyrolysis process is treated with potassium permanganate under an acidic condition, thereby obtaining carbon black including a hydroxyl group and/or a carboxyl group on its surface. Moreover, in JP 6856781 B, carbon black obtained from a pyrolysis process is treated with an amino acid compound including at least one thiol group or disulfide group, thereby obtaining carbon black whose surface is activated. Examples of the recovered carbon black relating to the present embodiment also include carbon black treated so as to include a functional group on its surface.

As the recovered carbon black, those commercially available from Strebl Green Carbon Pte Ltd., LD Carbon, etc. can be used.

A nitrogen adsorption specific surface area (N₂SA) of carbon black is preferably greater than 80 m²/g, more preferably greater than 100 m²/g, further preferably greater than 120 m²/g, from the viewpoints of weather resistance and reinforcing property. Moreover, the N₂SA is preferably less than 250 m²/g, more preferably less than 220 m²/g, further preferably less than 180 m²/g, further preferably less than 150 m²/g, from the viewpoints of dispersibility, fuel efficiency, fracture characteristics, and durability. The N₂SA of the carbon black is measured by the above-described measuring method.

An average primary particle size of carbon black is preferably greater than 12 nm, more preferably greater than 15 nm, further preferably greater than 17 nm, from the viewpoints of weather resistance and reinforcing property. Moreover, the average primary particle size is preferably less than 25 nm, more preferably less than 22 nm, further preferably less than 20 nm, from the viewpoints of dispersibility, fuel efficiency, fracture characteristics, and durability. The average primary particle size of the carbon black is measured by the above-described measuring method.

A content of carbon black based on 100 parts by mass of the rubber component is preferably greater than 1 part by mass, more preferably greater than 3 parts by mass, further preferably 5 parts by mass or more, from the viewpoints of weather resistance and reinforcing property. Moreover, the content is preferably less than 80 parts by mass, more preferably less than 70 parts by mass, further preferably less than 60 parts by mass, from the viewpoint of fuel efficiency. The content means that it also includes a content of recovered carbon black.

A total content of silica and carbon black based on 100 parts by mass of the rubber component is preferably greater than 20 parts by mass, more preferably greater than 25 parts by mass, further preferably 30 parts by mass or more, from the viewpoint of abrasion resistance. Moreover, it is preferably less than 180 parts by mass, more preferably less than 130 parts by mass, further preferably less than 110 parts by mass, from the viewpoint of suppressing deterioration of fuel efficiency and abrasion resistance.

### (Other Compounding Agents)

The rubber composition can appropriately comprise compounding agents conventionally and commonly used in the tire industry, for example, a plasticizing agent, a vulcanized rubber particle (rubber powder), an antioxidant, wax, processing aid, stearic acid, zinc oxide, a vulcanizing agent, a vulcanization accelerator, and the like, in addition to the above-described components.

### <<Plasticizing Agent>>

Examples of the plasticizing agent include a resin component, oil, a liquid rubber, an ester-based plasticizing agent, and the like. These plasticizing agents may be ones derived from mineral resources such as petroleum, natural gas, and the like, ones derived from biomass, or ones derived from naphtha recycled from a rubber product or non-rubber product. Moreover, low-molecular-weight hydrocarbon components obtained by pyrolyzing used tires or products containing various components and performing extraction from the pyrolysate may be used as plasticizing agents. The plasticizing agents may be used alone, or two or more thereof may be used in combination.

### Resin Component

The rubber composition relating to the present embodiment may comprise a resin component in combination. The resin component that can be used in the present embodiment is not particularly limited, and any resin commonly used in the tire industry can be used, examples of which include, for example, a C9-based resin, a C5-based resin, a C5/C9-based resin, a dicyclopentadiene-based resin, an aromatic vinyl-based resin, a coumarone-based resin, an indene-based resin, a terpene-based resin, a rosin-based resin, a phenol-based resin, and the like. These resin components may be used alone, or two or more thereof may be used in combination. Each resin component may also be used alone, or two or more thereof may be used in combination, respectively.

### C9-Based Resin

A “C9-based resin” refers to a resin obtained by polymerizing C9 fractions, and may be a polymer obtained by polymerizing a C9 fraction alone or a copolymer obtained by copolymerizing a C9 fraction with other components. For example, a resin obtained by copolymerizing dicyclopentadiene (DCPD) with a C9 fraction is referred to as a DCPD/C9 resin. Moreover, the C9-based resin may be one obtained by hydrogenating or modifying it. Examples of the C9 fraction include, for example, a petroleum fraction having 8 to 10 carbon atoms such as vinyltoluene, alkylstyrene, coumarone, indene, methylindene, dicyclopentadiene, and the like. As the C9-based resin, for example, those commercially available from BASF, Zeon Corporation, ENEOS Corporation, etc. can be used.

### C5-Based Resin

A “C5-based resin” refers to a resin obtained by polymerizing C5 fractions and may be one obtained by hydrogenating or modifying it. Examples of C5 fractions other than dicyclopentadiene include, for example, a petroleum fraction having 4 to 5 carbon atoms, such as cyclopentadiene, isoprene, piperylene, 2-methyl-1-butene, 2-methyl-2-butene, 1-pentene, and the like. As the C5-based resin, for example, those commercially available from STRUKTOL, Zeon Corporation, ENEOS Corporation, etc. can be used.

### C5/C9-Based Resin

A “C5/C9-based resin” refers to a resin obtained by copolymerizing the C5 fraction and the C9 fraction and may be one obtained by hydrogenating or modifying it. As the C5/C9-based resin, for example, those commercially available from Tosoh Corporation, Zibo Luhua Hongjin New Material Group Co., Ltd, etc. can be used.

### Dicyclopentadiene-Based Resin

A “dicyclopentadiene-based resin” refers to a resin comprising cyclopentadiene (CPD) and/or dicyclopentadiene (DCPD) as a monomer component having the largest content and may be one obtained by hydrogenating or modifying it. As the dicyclopentadiene-based resin, for example, a polymer obtained by polymerizing only dicyclopentadiene as a monomer, a copolymer obtained by copolymerizing dicyclopentadiene with the C9 fraction (DCPD/C9 resin), and the like are preferable. As the dicyclopentadiene-based resin, for example, those commercially available from Exxon Mobil Corporation, ENEOS Corporation, Zeon Corporation, Maruzen Petrochemical Co., Ltd., etc. can be used.

### Aromatic Vinyl-Based Resin

An “aromatic vinyl-based resin” refers to a resin comprising an aromatic vinyl compound such as styrene, α-methylstyrene, vinyltoluene, p-chlorostyrene, and the like as a monomer component having the largest content, and may be one obtained by hydrogenating or modifying it. As the aromatic vinyl-based resin, a homopolymer of α-methylstyrene or styrene or a copolymer of α-methylstyrene and styrene is preferable, and a copolymer of α-methylstyrene and styrene is more preferable, because it is economical, easy to process, and excellent in heat generation. As the aromatic vinyl-based resin, for example, those commercially available from Kraton Corporation, Eastman Chemical Company, Mitsui Chemicals, Inc., etc. can be used.

### Coumarone-Based Resin

A “coumarone-based resin” refers to a resin comprising coumarone as a monomer component and may be one obtained by hydrogenating or modifying it. As the coumarone-based resin, for example, a coumarone resin that is a polymer comprising only coumarone as a monomer component, a coumarone-indene resin that is a copolymer comprising coumarone and indene as monomer components, a coumarone-indene-styrene resin that is a copolymer comprising coumarone, indene, and styrene as monomer components, and the like are preferable. As the coumarone-based resin, for example, those commercially available from Rutgers Chemicals, Nitto Chemical Co., Ltd., Mitsui Chemicals, Inc., etc. can be used.

### Indene-Based Resin

An “indene-based resin” refers to a resin comprising indene as a monomer component and may be one obtained by hydrogenating or modifying it. As the indene-based resin, for example, a coumarone-indene resin that is a copolymer comprising coumarone and indene as monomer components, a coumarone-indene-styrene resin that is a copolymer comprising coumarone, indene, and styrene as monomer components, and the like are preferable. As the indene-based resin, for example, those commercially available from Rutgers Chemicals, Nitto Chemical Co., Ltd., Mitsui Chemicals, Inc., etc. can be used.

### Terpene-Based Resin

A “terpene-based resin” refers to a resin comprising a terpene compound such as α-pinene, β-pinene, limonene, dipentene, and the like as a monomer component, and may be one obtained by hydrogenating or modifying it. As the terpene-based resin, for example, a polyterpene resin that is a polymer comprising only one or more of the terpene compounds as monomer components, an aromatic-modified terpene resin that is a copolymer comprising the terpene compound and an aromatic compound as monomer components, a terpene phenolic resin that is a copolymer comprising the terpene compound and a phenol compound as monomer components, and the like are preferable. Examples of the aromatic compound used as a monomer component for the aromatic-modified terpene resin include, for example, styrene, α-methylstyrene, vinyltoluene, divinyltoluene, and the like. Examples of the phenol compound used as a monomer component for the terpene phenolic resin include, for example, phenol, bisphenol A, cresol, xylenol, and the like. As the terpene-based resin, for example, those commercially available from Yasuhara Chemical Co., Ltd., Arakawa Chemical Industries, Ltd., Nippon Terpene Chemicals, Inc., etc. can be used.

### Rosin-Based Resin

A “rosin-based resin” refers to a resin comprising a rosin acid compound such as abietic acid, neoabietic acid, palustric acid, isopimaric acid, and the like, and may be one obtained by hydrogenating or modifying it. Example of the rosin-based resin include, but not particularly limited to, for example, a natural resin rosin, a rosin-modified resin obtained by modifying the natural resin rosin by hydrogenation, disproportionation, dimerization, esterification, etc., and the like. As the rosin-based resin, for example, those commercially available from Harima Chemicals Group, Inc., Arakawa Chemical Industries, Ltd., IREC Co., Ltd., etc. can be used.

### Phenol-Based Resin

A “phenol-based resin” refers to a resin comprising a phenolic compound such as phenol, cresol, and the like as a monomer component, and may be one obtained by hydrogenating or modifying it. Examples of the phenol-based resin include, but not particularly limited to, a phenol formaldehyde resin, an alkylphenol formaldehyde resin, an alkylphenol acetylene resin, an oil-modified phenol formaldehyde resin, a terpene phenolic resin, and the like. As the phenol-based resin, for example, those commercially available from Sumitomo Bakelite Co., Ltd., DIC Corporation, ASAHI YUKIZAI CORPORATION, etc. can be used.

A softening point of resin is preferably higher than 80° C., more preferably higher than 90° C., further preferably higher than 100° C., from the viewpoint of wet grip performance. Moreover, it is preferably lower than 150° C., more preferably lower than 140° C., further preferably lower than 130° C., from the viewpoints of processability and improvement in dispersibility of a filler in a rubber component. The softening point of the resin is measured by the above-described measuring method.

A content of resin based on 100 parts by mass of the rubber component is preferably greater than 1 part by mass, more preferably greater than 5 parts by mass, further preferably 5 parts by mass or more. On the other hand, the content is preferably less than 60 parts by mass, more preferably less than 30 parts by mass, further preferably less than 20 parts by mass, from the viewpoint of suppression of heat generation.

### Oil

Examples of oil include, for example, mineral oils, vegetable oils, animal oils, and the like. Moreover, from the viewpoint of a life cycle assessment, one obtained by refining a waste oil after use for a rubber mixing machine or an engine or waste cooking oil used in a cooking facility may also be used. The oils may be used alone, or two or more thereof may be used in combination.

“Mineral oil” refers to oil derived from mineral resources such as petroleum, natural gas, and the like. Examples of mineral oil include paraffinic oils (mineral oils), naphthenic oils, aromatic oils, and the like. Specific examples of the mineral oils include, for example, MES (Mild Extracted Solvate), DAE (Distillate Aromatic Extract), TDAE (Treated Distillate Aromatic Extract), TRAE (Treated Residual Aromatic Extract), RAE (Residual Aromatic Extract), and the like. Moreover, as an environmental measure, oils each having a low content of a polycyclic aromatic compound (PCA) can also be used. Examples of the oils each having a low content of a PCA include MES, TDAE, heavy naphthenic oil, and the like.

Examples of the vegetable oils include, for example, a linseed oil, a rapeseed oil, a safflower oil, a soybean oil, a corn oil, a cottonseed oil, a rice bran oil, a tall oil, a sesame oil, perilla oil, a castor oil, a tung oil, a pine oil, a pine tar oil, a sunflower oil, a coconut oil, a palm oil, a palm kernel oil, an olive oil, a camellia oil, a jojoba oil, a macadamia nut oil, a peanut oil, a grapeseed oil, a Japan wax, and the like. Furthermore, examples of the vegetable oils also include a refined oil obtained by refining the above-described oil (a salad oil, etc.), a transesterified oil obtained by transesterifying the above-described oil, a hydrogenated oil obtained by hydrogenating the above-described oil, a thermally polymerized oil obtained by thermally polymerizing the above-described oil, an oxidized polymerized oil obtained by oxidizing the above-described oils, a waste cooking oil obtained by recovering what was utilized as an edible oil, etc., and the like. Besides, the vegetable oil may be liquid or solid at 25° C.

The vegetable oil preferably comprises acylglycerol, and more preferably comprises triacylglycerol. Besides, in the present specification, acylglycerol refers to a compound in which a hydroxy group of glycerin and a fatty acid are ester-bonded. The acylglycerol is not particularly limited and may be 1-monoacylglycerol, 2-monoacylglycerol, 1,2-diacylglycerol, 1,3-diacylglycerol, or triacylglycerol. Furthermore, the acylglycerol may be a monomer, a dimer, or a multimer that is a trimer or higher. Besides, acylglycerol that is a dimer or higher can be obtained by thermal polymerization, oxidative polymerization, or the like. Moreover, the acylglycerol may be liquid or solid at 25° C.

Whether the rubber composition comprises the above-described acylglycerol can be confirmed by, but not particularly limited to, ¹H-NMR measurement. For example, a heavy chloroform in which a rubber composition containing triacylglycerol is immersed at 25° C. for 24 hours and then removed is subjected to ¹H-NMR measurement at room temperature, and signals near 5.26 ppm, near 4.28 ppm, and near 4.15 ppm are observed under a condition that a signal of tetramethylsilane (TMS) is set to 0.00 ppm. These signals are presumed to be derived from hydrogen atoms bonded to carbon atoms adjacent to oxygen atoms of the ester group. Besides, “near” in this paragraph shall be a range of ±0.10 ppm.

The above-described fatty acid is not particularly limited and may be an unsaturated fatty acid or a saturated fatty acid. Examples of the unsaturated fatty acid include monounsaturated fatty acids such as oleic acid and the like; and polyunsaturated fatty acids such as linoleic acid, linolenic acid, and the like. Moreover, examples of the saturated fatty acid include butyric acid, lauric acid, and the like.

Among them, as the above-described fatty acid, a fatty acid having few double bonds, that is, a saturated fatty acid or a monounsaturated fatty acid is desired, and oleic acid is preferable. As a vegetable oil comprising such fatty acid, for example, a vegetable oil comprising a saturated fatty acid or a monounsaturated fatty acid or a vegetable oil refined by transesterification or the like may be used. Moreover, in order to produce a vegetable oil comprising such fatty acid, a plant may be improved by selective breeding, gene recombination, genome editing, or the like.

As a vegetable oil, for example, those commercially available from Idemitsu Kosan Co., Ltd., Sankyo Yuka Kogyo K. K., ENEOS Corporation, Olisoy, H&R Group, HOKOKU Corporation, Fuji Kosan Co., Ltd., The Nisshin Oillio Group, etc. can be used.

Examples of the animal oils include fish oils, beef tallow, oleyl alcohol derived therefrom, and the like.

A content of oil when compounded based on 100 parts by mass of the rubber component is preferably 1 part by mass or more, more preferably 5 parts by mass or more, further preferably 10 parts by mass or more, from the viewpoint of processability. Moreover, it is preferably 120 parts by mass or less, more preferably 60 parts by mass or less, further preferably 30 parts by mass or less, from the viewpoint of abrasion resistance. The content of oil also includes an amount of oil contained in an oil-extended rubber.

### Liquid Rubber

The liquid rubber is not particularly limited as long as it is a polymer in a liquid state at 25° C., examples of which include, for example, a liquid butadiene rubber (liquid BR), a liquid styrene-butadiene rubber (liquid SBR), a liquid isoprene rubber (liquid IR), a liquid styrene-isoprene rubber (liquid SIR), a liquid farnesene rubber, and the like. The liquid rubber may be used alone, or two or more thereof may be used in combination.

A content of a liquid rubber when compounded based on 100 parts by mass of the rubber component is preferably 1 part by mass or more, more preferably 3 parts by mass or more, further preferably 5 parts by mass or more. Moreover, the content of the liquid rubber is preferably 50 parts by mass or less, more preferably 30 parts by mass or less, further preferably 10 parts by mass or less. The content of the liquid rubber also includes an amount of an extending liquid rubber used for extending a rubber component.

### Ester-Based Plasticizing Agent

Examples of the ester-based plasticizing agent include, for example, dibutyl adipate (DBA), diisobutyl adipate (DIBA), dioctyl adipate (DOA), di(2-ethylhexyl) azelate (DOZ), dibutyl sebacate (DBS), diisononyl adipate (DINA), diethyl phthalate (DEP), dioctyl phthalate (DOP), diundecyl phthalate (DUP), dibutyl phthalate (DBP), dioctyl sebacate (DOS), tributyl phosphate (TBP), trioctyl phosphate (TOP), triethyl phosphate (TEP), trimethyl phosphate (TMP), thymidine triphosphate (TTP), tricresyl phosphate (TCP), trixylenyl phosphate (TXP), and the like. These ester-based plasticizing agents may be used alone, or two or more thereof may be used in combination.

A content of an ester-based plasticizing agent when compounded based on 100 parts by mass of the rubber component is preferably 1 part by mass or more, more preferably 3 parts by mass or more, further preferably 5 parts by mass or more. Moreover, the content of the liquid rubber is preferably 50 parts by mass or less, more preferably 30 parts by mass or less, further preferably 10 parts by mass or less. The content of the ester-based plasticizing agent also includes an amount of an extending ester-based plasticizing agent used for extending a rubber component.

### <<Vulcanized Rubber Particle>>

The vulcanized rubber particle is a particle made of a vulcanized rubber. Specifically, a rubber powder specified in JIS K6316:2017, and the like can be used. A recycled rubber powder produced from a pulverized product of a waste tire and the like is preferable from the viewpoints of consideration for environment and cost. The vulcanized rubber particle may be used alone, or two or more thereof may be used in combination.

The vulcanized rubber particle is not particularly limited and may be an unmodified vulcanized rubber particle or a modified vulcanized rubber particle. As a commercially available product of a vulcanized rubber, for example, products manufactured by Lehigh Technologies, Muraoka Rubber Reclaiming Co., Ltd. etc. can be used.

A content of a vulcanized rubber particle when compounded based on 100 parts by mass of the rubber component can be appropriately adjusted, for example, within a range of greater than 1 part by mass and less than 80 parts by mass.

### <<Antioxidant>>

Examples of the antioxidant include, but not particularly limited to, a naphthylamine-based antioxidant such as phenyl-α-naphthylamine and the like; a diphenylamine-based antioxidant such as octylated diphenylamine, 4,4′-bis(α,α′-dimethylbenzyl)diphenylamine, and the like; a p-phenylenediamine-based antioxidant such as N-isopropyl-N′-phenyl-p-phenylenediamine, N-(1,3-dimethylbutyl)-N′-phenyl-p-phenylenediamine (6PPD), N,N′-bis(1,4-dimethylpentyl)-p-phenylenediamine (77PD), N,N′-diphenyl-p-phenylenediamine (DPPD), N,N′-ditolyl-p-phenylenediamine (DTPD), N-isopropyl-N′-phenyl-p-phenylenediamine (IPPD), N,N′-di-2-naphthyl-p-phenylenediamine (DNPD), and the like; a quinoline-based antioxidant such as a polymer of 2,2,4-trimethyl-1,2-dihydroquinoline and the like; a monophenol-based antioxidant such as 2,6-di-t-butyl-4-methylphenol, styrenated phenol, and the like; bisphenol-based, trisphenol-based, or polyphenol-based antioxidants such as tetrakis-[methylene-3-(3′,5′-di-t-butyl-4′-hydroxyphenyl) propionate]methane and the like; and the like. Among them, the p-phenylenediamine-based antioxidant and the quinoline-based antioxidant are preferable, and N-(1,3-dimethylbutyl)-N′-phenyl-p-phenylenediamine and a polymer of 2,2,4-trimethyl-1,2-dihydroquinoline are more preferable. As the commercially-available product, for example, products manufactured by Seiko Chemical Co., Ltd., Sumitomo Chemical Co., Ouchi Shinko Chemical Industry Co., Flexsys, etc. can be used. The antioxidant may be used alone, or two or more thereof may be used in combination.

A content of an antioxidant when compounded based on 100 parts by mass of the rubber component is preferably 0.5 parts by mass or more, more preferably 1 part by mass or more, from the viewpoint of ozone crack resistance of a rubber. Moreover, it is preferably 10 parts by mass or less, more preferably 5 parts by mass or less, from the viewpoints of abrasion resistance and wet grip performance.

### <<Wax>>

Wax is not particularly limited, and any of those commonly used in the tire industry can be appropriately used, examples of which include, for example, a mineral-based wax, a plant-derived wax, and the like. The mineral-based wax refers to a wax derived from mineral resources such as oil, natural gas, and the like. The plant-derived wax refers to a wax derived from natural resources such as plants. Among them, the mineral-based wax is preferable. Examples of the plant-derived wax include, for example, a rice bran wax, a carnauba wax, a candelilla wax, and the like. Examples of the mineral-based wax include, for example, a paraffin wax, a microcrystalline wax, a specially selected wax thereof, and the like, and the paraffin wax is preferable. Besides, the wax relating to the present embodiment shall not include stearic acid. As wax, for example, those commercially available from Ouchi Shinko Chemical Industry Co., Nippon Seiro Co., Ltd., PARAMELT, etc. can be used. The wax may be used alone, or two or more thereof may be used in combination.

A content of wax when compounded based on 100 parts by mass of the rubber component is preferably 0.5 parts by mass or more, more preferably 1 part by mass or more, from the viewpoint of weather resistance of a rubber. Moreover, it is preferably 10 parts by mass or less, more preferably 5 parts by mass or less, from the viewpoint of prevention of whitening of a tire due to bloom.

### <<Processing Aid>>

Examples of processing aid include, for example, a fatty acid metal salt, a fatty acid amide, an amide ester, a silica surfactant, a fatty acid ester, a mixture of a fatty acid metal salt and an amide ester, a mixture of a fatty acid metal salt and a fatty acid amide, and the like. As processing aid, for example, those commercially available from Schill+Seilacher GmbH, Performance Additives, etc. can be used. The processing aid may be used alone, or two or more thereof may be used in combination.

A content of processing aid when compounded based on 100 parts by mass of the rubber component is preferably 0.5 parts by mass or more, more preferably 1 part by mass or more, from the viewpoint of exerting an effect of improving processability. Moreover, it is preferably 10 parts by mass or less, more preferably 8 parts by mass or less, further preferably 5 parts by mass or less, from the viewpoints of abrasion resistance and breaking strength.

### <<Stearic Acid>>

A content of stearic acid when compounded based on 100 parts by mass of the rubber component is preferably 0.5 parts by mass or more, more preferably 1 part by mass or more, from the viewpoint of processability. Moreover, it is preferably 10 parts by mass or less, more preferably 5 parts by mass or less, from the viewpoint of vulcanization rate.

### <<Zinc Oxide>>

A content of zinc oxide when compounded based on 100 parts by mass of the rubber component is preferably 0.5 parts by mass or more, more preferably 1.0 parts by mass or more, further preferably 1.5 parts by mass or more, from the viewpoint of processability. Moreover, it is preferably 5.0 parts by mass or less, more preferably 4.5 parts by mass or less, further preferably 4.0 parts by mass or less, from the viewpoint of abrasion resistance.

### <<Vulcanizing Agent>>

Sulfur is appropriately used as a vulcanizing agent. As sulfur, a powdery sulfur, an oil processing sulfur, a precipitated sulfur, a colloidal sulfur, an insoluble sulfur, a highly dispersible sulfur, and the like can be used. The vulcanizing agent can be used alone, or two or more thereof can be used in combination.

A content of sulfur when compounded as a vulcanizing agent based on 100 parts by mass of the rubber component is preferably 0.1 parts by mass or more, more preferably 0.3 parts by mass or more, further preferably 0.5 parts by mass or more, from the viewpoint of securing a sufficient vulcanization reaction. Moreover, it is preferably 5.0 parts by mass or less, more preferably 4.0 parts by mass or less, further preferably 3.0 parts by mass or less, from the viewpoint of prevention of deterioration. Besides, a content of a vulcanizing agent when an oil-containing sulfur is used as the vulcanizing agent is defined as a total content of pure sulfur contained in the oil-containing sulfur.

Examples of the vulcanizing agent other than sulfur include, for example, an alkylphenol-sulfur chloride condensate, sodium hexamethylene-1,6-bisthiosulfate dihydrate, 1,6-bis(N,N′-dibenzylthiocarbamoyldithio)hexane, and the like. As these vulcanizing agents other than sulfur, those commercially available from Taoka Chemical Co., Ltd., LANXESS, Flexsys, etc. can be used. The vulcanizing agent can be used alone, or two or more thereof can be used in combination.

### <<Vulcanization Accelerator>>

Examples of the vulcanization accelerator include, for example, sulfenamide-based, thiazole-based, thiuram-based, thiourea-based, guanidine-based, dithiocarbamic acid-based, aldehyde-amine-based or aldehyde-ammonia-based, imidazoline-based, and xanthate-based vulcanization accelerators, and the like. Among them, a sulfenamide-based vulcanization accelerator, a thiazole-based vulcanization accelerator, and a guanidine-based vulcanization accelerator are preferable. The vulcanization accelerator may be used alone, or two or more thereof may be used in combination.

Examples of the sulfenamide-based vulcanization accelerator include, for example, N-tert-butyl-2-benzothiazolyl sulfenamide (TBBS), N-cyclohexyl-2-benzothiazolyl sulfenamide (CBS), N,N-dicyclohexyl-2-benzothiazolyl sulfenamide (DCBS), and the like. Among them, N-cyclohexyl-2-benzothiazolyl sulfenamide (CBS) is preferable.

Examples of the thiazole-based vulcanization accelerator include, for example, 2-mercaptobenzothiazole, a cyclohexylamine salt of 2-mercaptobenzothiazole, di-2-benzothiazolyl disulfide, and the like. Among them, 2-mercaptobenzothiazole is preferable.

Examples of the guanidine-based vulcanization accelerator include, for example, 1,3-diphenylguanidine (DPG), 1,3-di-o-tolylguanidine, 1-o-tolylbiguanide, di-o-tolylguanidine salt of dicatechol borate, 1,3-di-o-cumenyl guanidine, 1,3-di-o-biphenyl guanidine, 1,3-di-o-cumenyl-2-propionyl guanidine, and the like. Among them, 1,3-diphenylguanidine (DPG) is preferable.

A content of a vulcanization accelerator when compounded based on 100 parts by mass of the rubber component is preferably 1 part by mass or more, more preferably 1.5 parts by mass or more. Moreover, the content of the vulcanization accelerator based on 100 parts by mass of the rubber component is preferably 8 parts by mass or less, more preferably 7 parts by mass or less, further preferably 6 parts by mass or less. When the content of the vulcanization accelerator is within the above-described ranges, breaking strength and elongation tend to be secured.

### (Various Materials Comprising Carbon Atoms)

In the present specification, various materials each having a carbon atom (for example, a rubber, oil, resin, a vulcanization accelerator, an antioxidant, a surfactant, and the like) may be derived from carbon dioxide in the atmosphere. These various materials can be obtained by converting carbon dioxide directly or converting methane obtained via a process of methanation by which methane is synthesized from carbon dioxide.

### <Adhesive Layer>

An adhesive layer is a layer composed of a resin-based adhesive. Generally, an adhesive is classified into an inorganic adhesive and an organic adhesive, and for the organic adhesive among them, a natural adhesive and a synthetic (a thermoplastic resin-based, a thermosetting resin-based, an elastomer-based, or the like) adhesive are known. The resin-based adhesive in the present embodiment falls under the thermoplastic resin-based or thermosetting resin-based adhesive among them.

Regarding an adhesive, examples of the thermoplastic resin-based adhesive include a vinyl acetate resin-based adhesive, a polyvinyl acetal-based adhesive, an ethylene vinyl acetate resin-based adhesive, a vinyl chloride resin-based adhesive, an acrylic resin-based (acrylic ester such as butyl acrylate and the like, etc.) adhesive, a polyamide-based adhesive, a cellulose-based adhesive, an α-olefin-based adhesive, and the like. Moreover, examples of the thermosetting resin-based adhesive include a urethane resin-based adhesive, a urea resin-based adhesive, a melamine resin-based adhesive, a phenolic resin-based adhesive, a resorcinol resin-based adhesive, an epoxy resin-based adhesive, a structural acrylic resin resin-based adhesive, a polyester-based adhesive, a polyaromatic adhesive, and the like. As a resin-based adhesive, commercially available ones can be used. The resin-based adhesive can be used alone, or two or more thereof can be used in combination.

A glass transition temperature (Tg) of a resin-based adhesive layer after curing is preferably higher than 20° C., more preferably higher than 30° C., further preferably higher than 40° C., further preferably higher than 50° C. Moreover, the Tg is preferably lower than 150° C., more preferably lower than 120° C., further preferably lower than 100° C., further preferably lower than 80° C.

As a resin-based adhesive, a urethane resin-based adhesive is preferable. The urethane resin-based adhesive is not particularly limited, examples of which can include, for example, an adhesive that exerts adhesion performance via urethane reaction. The urethane resin-based adhesive can be used alone, or two or more thereof can be used in combination.

### <Producing Method>

The retreaded tire can be produced by a known method.

The rubber composition constituting a tread member can be produced by a known method. For example, it can be produced by kneading the respective above-described components with a rubber kneading machine such as an open roll, a sealed type kneader (a Banbury mixer, a kneader, and the like), and the like. The kneading step includes, for example, a base kneading step of kneading compounding agents and additives other than a vulcanizing agent and a vulcanization accelerator; and a final kneading (F-kneading) step of adding the vulcanizing agent and the vulcanization accelerator to the kneaded product obtained in the base kneading step and kneading them. Additionally, the base kneading step can be also divided into multiple steps as necessary. Examples of kneading conditions include, but not particularly limited to, for example, a method of kneading at a discharge temperature of 150° C. to 170° C. for 3 to 10 minutes in the base kneading step and kneading at 70° C. to 110° C. for 1 to 5 minutes in the final kneading step.

The tread member can be produced using the above-described rubber composition by a usual method. That is, the tread member can be produced by extruding the unvulcanized rubber composition into a shape of the tread member with an extruder equipped with a mouthpiece having a predetermined shape, followed by heating and pressurizing it in a vulcanizer. Examples of the vulcanization condition include, but not particularly limited to, for example, a method of vulcanizing at 140° C. to 170° C. for 10 to 40 minutes. Besides, it is preferable to previously perform buff polishing processing on a bonding surface of the tread member to a base tire.

On the other hand, the base tire can be produced by removing a tread part from a tire whose tread is abraded due to use of the tire or by attaching respective unvulcanized tire members constituting the base tire together so that it has a predetermined base tire structure, and molding them by a usual method, on a tire molding machine, to form an unvulcanized base tire, followed by heating and pressurizing this unvulcanized base tire in a vulcanizer. Examples of a vulcanization condition include, but not particularly limited to, for example, a method of vulcanizing at 140° C. to 170° C. for 10 to 40 minutes. Besides, it is preferable to previously perform buff polishing treatment on a bonding surface of the base tire to the tread member.

An adhesive layer composed of a resin-based adhesive is arranged between the tread member and the base tire thus obtained. As a method of arranging the adhesive layer, an adhesive sheet formed by forming a film of an adhesive may be arranged between the base tire and the tread member, or the tread member may be mounted on the base tire after the adhesive is applied to the surface of at least one of the base tire and the tread member. From the viewpoint of easily performing the step of arranging the adhesive layer, the method using the adhesive sheet is preferable. Moreover, in a case where the adhesive layer is thinned, the method in which the adhesive is applied to the surface of at least one of the base tire and the tread member is preferable.

The adhesive sheet can be appropriately produced by applying an adhesive on a release sheet such as a release paper, a release film, and the like and maintaining a sheet shape. Alternatively, the adhesive sheet can be produced by applying an adhesive to a surface of a member to be attached and maintaining it. Although the maintenance can be carried out by leaving the adhesive as it is at normal temperature, it can be carried out not only by merely leaving it as it is but also by performing at least one of heating and light irradiation to such an extent that a radical reaction does not begin, thereby facilitating a partial urethane reaction. Light irradiation may be visible light irradiation or can also be ultraviolet irradiation.

A material of the release sheet is not particularly limited, and in addition to a polyester-based resin such as polyethylene terephthalate, polycyclohexylene terephthalate, polyethylene naphthalate, and the like; a polyamide-based resin such as Nylon 46, a modified Nylon 6T, Nylon MXD6, polyphthalamide, and the like; a ketone-based resin such as polyphenylene sulfide, polythioethersulfone, and the like; and a sulfone-based resin such as polysulfone, polyethersulfone, and the like, a transparent resin substrate containing, as a main component, an organic resin such as polyether nitrile, polyarylate, polyetherimide, polyamide imide, polycarbonate, polymethyl methacrylate, triacetylcellulose, polystyrene, polyvinyl chloride, and the like can be appropriately used. It is preferable that a thickness of the adhesive sheet (however, a part excluding a release sheet) is, for example, 0.1 mm or more and 3 mm or less.

Examples of the method of applying the resin-based adhesive can include various application methods, for example, such as an application method by manual work or work using instrument such as brush application, roller brush application, pad application, spatula application, and the like; an application method by ink jet printing; a spray coating method such as spray coating, hot spray coating, airless spray coating, hot airless spray coating, and the like; curtain flow coating; flow coating; roll coating; gravure coating; dip coating (dipping); tumbling coating; spin coating; reverse coating; bar coating; screen coating; blade coating; air knife coating; dispensing with a dispenser; a T-die molding method; a thin film extrusion molding method; and the like. Also in an application method in a case where an adhesive sheet is formed by applying an adhesive to a release sheet or the like, the above-described application methods have only to be performed.

A tire in which an adhesive layer composed of a resin-based adhesive is arranged between a tread member and a base tire can become a retreaded tire by hardening the adhesive layer while leaving the adhesive layer as it is.

### <Application>

The retreaded tire relating to the present embodiment can be used for various applications and can be appropriately used as a retreaded tire, for example, for aircraft, for maglev vehicles, or for trucks/buses.

### Example

Hereinafter, examples considered to be preferable in implementing the present invention (Examples) will be described, though the scope of the present invention is not limited to only these Examples. Results, which are calculated based on evaluation methods described below considering a tread member and a base tire, the tread member being composed of a rubber composition obtained in accordance with each Table using various chemicals described below, are shown.

### [Various Chemicals]

Various materials used in Examples and Comparative examples are collectively shown below.
IR-based rubber: NR (TSR20)
SBR: SL553R manufactured by JSR Corporation (styrene content: 10% by mass, vinyl content: 37 mol %, Tg: −60° C.)
BR: BR730 manufactured by JSR Corporation (BR synthesized using a Nd-based catalyst, cis content: 96.6 mol %, Mw: 580,000)
CB (carbon black): Show Black N134 manufactured by Cabot Japan K.K. (N₂SA: 148 m²/g, average primary particle size: 18 nm)
Silica: Ultrasil (Registered Trademark) 9100GR manufactured by Evonik Industries AG (N₂SA: 235 m²/g, average primary particle size: 15 nm)
Coupling agent (Silane coupling agent): Si266 manufactured by Evonik Industries AG (bis(3-triethoxysilylpropyl)disulfide)
Oil: Diana process NH-70S manufactured by Idemitsu Kosan Co., Ltd
Zinc oxide: Zinc oxide No. 1 manufactured by Mitsui Mining & Smelting Co., Ltd.
Antioxidant: Nocrac 6C manufactured by Ouchi Shinko Chemical Industry Co., Ltd. (N-(1,3-dimethylbutyl)-N′-phenyl-p-phenylenediamine)
Stearic acid: Bead stearic acid “CAMELLIA” manufactured by NOF CORPORATION
Wax: OZOACE 0355 manufactured by Nippon Seiro Co., Ltd. (paraffin wax)
Sulfur: 5% oil processing powdered sulfur manufactured by Tsurumi Chemical Industry Co., ltd.
Vulcanization accelerator: Nocceler NS-P manufactured by Ouchi Shinko Chemical Industry Co., Ltd. (N-tert-butyl-2-benzothiazolylsulfenamide (TBBS))
Resin-based adhesive: BetaFuse manufactured by DuPont.

### EXAMPLES AND COMPARATIVE EXAMPLES

### <Tread Member>

According to a tire structure and compounding formulations shown in each Table, a tread member is prepared. First, using a 1.7 L closed Banbury mixer, all chemicals other than sulfur and a vulcanization accelerator are kneaded for 1 to 10 minutes until a temperature reaches a discharge temperature at 150° C. to 160° C. to obtain a kneaded product. Next, using a twin-screw open roll, the sulfur and the vulcanization accelerator are added to the obtained kneaded product, and the mixture is kneaded for 4 minutes until the temperature reaches 105° C. to obtain an unvulcanized rubber composition. The obtained unvulcanized rubber composition is used to be extruded into a shape of a tread with an extruder equipped with a mouthpiece having a predetermined shape, which is then press-vulcanized under a condition at 170° C. for 12 minutes, thereby producing each tread member (tire size: 11R22.5). Buff polishing treatment is previously performed on a bonding surface of each tread member to a base tire.

### <Base Tire>

Respective tire members excluding a tread part are attached together to produce a green tire for base tire, and this is press-vulcanized under a condition at 170° C. for 12 minutes, thereby preparing a base tire. Buff polishing treatment is previously performed on an outer surface of the base tire on the outermost side in a tire radial direction, that is, a bonding surface to a new tread member.

### <Retreaded Tire>

According to Table 2 or 4, a resin-based adhesive is applied to the bonding surface of the base tire and the bonding surface of the tread member so as to have a predetermined thickness, and both of the bonding surfaces are boned together, thereby obtaining a retreaded tire.

### [Evaluation]

Results measured by a method described below for each retreaded tire are described in the corresponding columns in Tables described below. Each retreaded tire is used after made into a standardized state, unless otherwise specified.

### <70° C. tan δ>

A vulcanized rubber test piece having a length of 20 mm, a width of 4 mm, and a thickness of 1 mm is cut out, as a sample for measurement, from a tread member of each retreaded tire. A length direction of the sample is configured to coincide with a tire circumferential direction, and a thickness direction of the sample is configured to coincide with a tire radial direction. A loss tangent (tan δ) is measured using the sample, by a dynamic viscoelasticity measuring device (EPLEXOR series manufactured by gabo Systemtechnik GmbH), under a condition of a temperature at 70° C., a frequency of 10 Hz, an initial strain of 10%, a dynamic strain of ±1%, and an extension mode.

### <Ride Comfort>

Each retreaded tire is mounted on all wheels of a vehicle with a displacement of 2000 cc. This vehicle is made to run at 100 km/h on a test course with an asphalt road surface, and 20 test drivers perform sensory evaluations on ride comfort. The evaluations are performed using an integer value of 1 to 5 points, and the higher the score is, the more excellent the ride comfort is. A total score for each retreaded tire is indicated as an index with a total score for the reference Comparative example being as 100.

TABLE 1
(Tread member)

Compounding

| Compounding (parts by mass) | 1 | 2 |
|---|---|---|
| IR-based rubber | 60 | 60 |
| BR | 40 | 40 |
| CB | 56 | 47 |
| Oil | 1.5 | 1.5 |
| Zinc oxide | 3 | 3 |
| Antioxidant | 2.5 | 2.5 |
| Stearic acid | 3.5 | 3.5 |
| Wax | 1.5 | 1.5 |
| Sulfur | 1.2 | 1.2 |
| Vulcanization accelerator | 1.8 | 1.8 |
| 70° C. tan δ | 0.14 | 0.09 |

TABLE 2

| | Example | | Comparative example | | | |
|---|---|---|---|---|---|---|
| Tire | 1 | 2 | 1 | 2 | 3 | 4 |
| Compounding of tread | 1 | 2 | 1 | 1 | 2 | 2 |
| member | | | | | | |
| Tc (mm) | 30 | 30 | 15 | 30 | 30 | 15 |
| Ta (mm) | 1 | 0.5 | 1 | 3 | 1 | 3 |
| Tc/Ta | 30.0 | 60.0 | 15.0 | 10.0 | 30.0 | 5.0 |
| 70° C. tan δ × (Tc/Ta) | 4.20 | 5.40 | 2.10 | 1.40 | 2.70 | 0.45 |
| Ride comfort index | 104 | 106 | 98 | 100 | 98 | 96 |

TABLE 3
(Tread member)

Compounding

| Compounding (parts by mass) | 3 | 4 | 5 |
|---|---|---|---|
| IR-based rubber | 60 | 60 | 60 |
| SBR | 20 | 20 | 20 |
| BR | 20 | 20 | 20 |
| CB | 30 | 5 | 30 |
| Silica | 30 | 55 | — |
| Coupling agent | 3 | 5.5 | — |
| Oil | 10 | 10 | 1 |
| Zinc oxide | 3 | 3 | 3 |
| Antioxidant | 2.5 | 2.5 | 2.5 |
| Stearic acid | 3.5 | 3.5 | 3.5 |
| Wax | 1.5 | 1.5 | 1.5 |
| Sulfur | 1.2 | 1.2 | 1.2 |
| Vulcanization accelerator | 1.8 | 1.8 | 1.8 |
| 70° C. tan δ | 0.18 | 0.14 | 0.04 |

TABLE 4

| | | | Comparative |
|---|---|---|---|
| | Example | | example |
| Tire | 3 | 4 | 5 |
| Compounding of tread member | 3 | 4 | 5 |
| Tc (mm) | 30 | 30 | 30 |
| Ta (mm) | 1 | 1 | 1 |
| Tc/Ta | 30.0 | 30.0 | 30.0 |
| 70° C. tan δ × (Tc/Ta) | 5.40 | 4.20 | 1.20 |
| Ride comfort index | 108 | 106 | 100 |

### EMBODIMENTS

Examples of preferred embodiments are described below.

<1> A retreaded tire comprising a base tire, a tread member, and an adhesive layer,
wherein the adhesive layer is arranged between the base tire and the tread member,
wherein the tread member is composed of a rubber composition,
wherein the adhesive layer is composed of a resin-based adhesive, and
wherein a value of 70° C. tan δ×(Tc/Ta) is 4.00 or more, preferably 4.10 or more,
where Tc represents a thickness, in mm, of the tread member, Ta represents a thickness, in mm, of the adhesive layer, and 70° C. tan δ represents a loss tangent at 70° C. of the rubber composition.

<2> The retreaded tire of <1> above, wherein the rubber composition comprises a styrene-butadiene rubber.

<3> The retreaded tire of <1> or <2> above, wherein the rubber composition comprises silica.

<4> The retreaded tire of <3> above, wherein an average primary particle size of the silica is less than 17 nm, preferably less than 16 nm, more preferably 15 nm or less.

<5> The retreaded tire of any one of <1> to <4> above, wherein Tc/Ta is greater than 25.0, preferably greater than 27.0, more preferably greater than 29.0, further preferably 30.0 or more.

<6> The retreaded tire of any one of <1> to <5> above, wherein Ta is less than 2.0, preferably less than 1.0.

<7> The retreaded tire of any one of <1> to <6> above, wherein the value of 70° C. tan δ×(Tc/Ta) is 4.20 or more, preferably 4.50 or more.

<8> The retreaded tire of any one of <1> to <6> above, wherein the value of 70° C. tan δ×(Tc/Ta) is 5.00 or more, preferably 5.20 or more, more preferably 5.30 or more, further preferably 5.40 or more.

<9> The retreaded tire of any one of <1> to <8> above, wherein a glass transition temperature of the adhesive layer after curing is higher than 20° C., preferable higher than 30° C., more preferably higher than 40° C., further preferably higher than 50° C.

<10> The retreaded tire of any one of <1> to <9> above, wherein the resin-based adhesive is a urethane resin-based adhesive.

<11> The retreaded tire of <3> or <4> above, wherein a content of the silica in the rubber composition is 70 parts by mass or less, preferably less than 60 parts by mass, more preferably 55 parts by mass or less, based on 100 parts by mass of the rubber component.

### REFERENCE SIGNS LIST

1. Retreaded tire
2. Tread member
3. Base tire
4. Carcass
5. Belt
6. Adhesive layer
CL. Tire center line
Tc. Thickness of tread member
Ta. Thickness of adhesive layer

What is claimed is:

1. A retreaded tire comprising a base tire, a tread member, and an adhesive layer,
wherein the adhesive layer is arranged between the base tire and the tread member,
wherein the tread member is composed of a rubber composition,
wherein the adhesive layer is composed of a resin-based adhesive, and
wherein a value of 70° C. tan δ×(Tc/Ta) is 4.00 or more,
where Tc represents a thickness, in mm, of the tread member, Ta represents a thickness, in mm, of the adhesive layer, and 70° C. tan δ represents a loss tangent at 70° C. of the rubber composition.

2. The retreaded tire of claim 1, wherein the rubber composition comprises a styrene-butadiene rubber.

3. The retreaded tire of claim 1, wherein the rubber composition comprises silica.

4. The retreaded tire of claim 3, wherein an average primary particle size of the silica is less than 17 nm.

5. The retreaded tire of claim 1, wherein Tc/Ta is greater than 25.0.

6. The retreaded tire of claim 1, wherein Ta is less than 2.0.

7. The retreaded tire of claim 1, wherein the value of 70° C. tan δ×(Tc/Ta) is 4.20 or more.

8. The retreaded tire of claim 1, wherein the value of 70° C. tan δ×(Tc/Ta) is 5.00 or more.

9. The retreaded tire of claim 1, wherein a glass transition temperature of the adhesive layer after curing is higher than 20° C.

10. The retreaded tire of claim 1, wherein the resin-based adhesive is a urethane resin-based adhesive.

11. The retreaded tire of claim 3, wherein a content of the silica in the rubber composition is 70 parts by mass or less based on 100 parts by mass of the rubber component.
